(19) United States
(12) Patent Application Publication
(10) Pub. No.: US 2017/0058829 A1
(43) Pub. Date: Mar. 2, 2017

(54) LOW FORWARD-TURNING CASACDE WITH HIGH-FORWARD-TURNING AFT VANE PASSAGES

(71) Applicant: Rohr, Inc., Chula Vista, CA (US)

(72) Inventor: Landy Dong, La Jolla, CA (US)

(21) Appl. No.: 14/836,706

(22) Filed: Aug. 26, 2015

(51) Int. Cl. F02K 1/70

(52) U.S. Cl. CPC F02K 1/70

(57) ABSTRACT

Aspects are directed to a system configured for use in connection with a thrust reverser of an aircraft, comprising: a first subset of cascade vanes having a first forward turning angle, and a second subset of cascade vanes having a second forward turning angle that is different from the first forward turning angle.

### BACKGROUND

A typical cascade-style, translating sleeve thrust reverser for a turbofan propulsion system includes a circumferential array of cascades. Cascades are frequently grill- or grate-like structures through which the majority of the fan bypass air from the propulsion system passes through during reverse thrust operation. The cascades' turning vanes direct the efflux of air in predetermined directions to produce reverse thrust whilst at the same time ensuring acceptable engine re-ingestion and aircraft stability and control is maintained during reverse operation. Often, a cascade array will contain low forward-turning vanes in a lower, inboard quadrant of the thrust reverser, and high forward-turning vanes in other quadrants. The low forward-turning vane cascades direct air outward from the thrust reverser, but only slightly forward, to avoid engine re-ingestion and fuselage-mounted instrumentation efflux impingement from occurring. High forward-turning vane cascades direct air outward and in a more forward direction to generate reverse thrust more efficiently than the low forward-turning vane cascades.

Referring to FIG. 1, a two-dimensional (2-D) representation of a thrust reverser system 100 incorporating low forward-turning vane cascades 104 is shown. In particular, FIG. 1 is associated with a deployed state of the thrust reverser. Relative to when the thrust reverser is stowed, a translating sleeve 116 is translated aft to expose/unblock one or more of the vanes included in the array 104 as described below.

In FIG. 1, a subset (denoted by reference character/circle 104a) of the cascade vanes 104 is blocked with a plug such as plate 110. The plate 110 is used to avoid efflux impingement on the translating sleeve 116 when one or more blocker doors (e.g., a blocker door 122) are deployed as shown. Otherwise, a subset 104b of the cascade vanes 104 is used to produce reverse thrust as a result of a redirection of a bypass flow by the blocker door 122. The use of the plate 110 represents a loss in performance/efficiency in terms of the production of reverse thrust.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a system configured for use in connection with a thrust reverser of an aircraft, comprising: a first subset of cascade vanes having a first forward turning angle, and a second subset of cascade vanes having a second forward turning angle that is different from the first forward turning angle. In some embodiments, the second subset of cascade vanes includes a plurality of cascade vanes. In some embodiments, the second subset of cascade vanes is a single cascade vane. In some embodiments, the second subset of cascade vanes are located aft of the first subset of cascade vanes. In some embodiments, the second forward turning angle is greater than the first forward turning angle relative to a radial reference direction. in some embodiments, the second forward turning angle is within a range of 35-50 degrees relative to a radial reference direction. In some embodiments, the second forward turning angle is approximately 40 degrees relative to a radial reference direction. In some embodiments, the first forward turning angle is within a range of 0-20 degrees relative to a radial reference direction. In some embodiments, the first forward turning angle is approximately 15 degrees relative to a radial reference direction. In some embodiments, the system comprises a blocker door configured to redirect a bypass flow through the first and second subsets of cascade vanes when the thrust reverser is deployed. In some embodiments, the system comprises a translating sleeve configured to unblock the first and second subsets of cascade vanes when the thrust reverser is deployed to generate reverse thrust via the first and second subsets of cascade vanes, In some embodiments, the second forward turning angle is greater than a threshold, and the threshold is based on an avoidance of an efflux impingement upon an inner surface of an outer panel of the translating sleeve when the thrust reverser is deployed.

Aspects of the disclosure are directed to a thrust reverser system of an aircraft comprising: a translating sleeve at least partially defining a bypass air duct in which a bypass air flow from a turbofan engine passes, the translating sleeve configured to translate in a generally forward-aft direction between a stowed position and a deployed position, a set of blocker doors linked to the translating sleeve which are positioned inside of the bypass air duct and at least partially block the bypass air flow when the translating sleeve is in the deployed position and are positioned in a second stowed position not blocking the bypass air flow when the translating sleeve is in the stowed position, a cascade array which is blocked by the translating sleeve when the translating sleeve is in the stowed position and is exposed by the translating sleeve when the translating sleeve is in the deployed position, the cascade array configured to redirect the bypass air flow in a generally forward direction when the translating sleeve is in the deployed position, the cascade array including a first subset of cascade turning vanes having a first forward turning angle, and a second subset of cascade vanes positioned aft of the first subset and having a second forward turning angle that is greater than the first forward turning angle. In some embodiments, the first forward turning angle and the second forward turning angle are measured relative to a radial reference direction. In some embodiments, the first forward turning angle is within a range of 0-20 degrees, and the second forward turning angle is within a range of 35-50 degrees.

### BRIEF DESCRIPT ON OF THE DRAWINGS

The present disclosure is illustrated by way of example and not limited in the accompanying figures in which like reference numerals indicate similar elements.

FIG. 1 illustrates a system associated with a thrust reverser in accordance with the prior art.

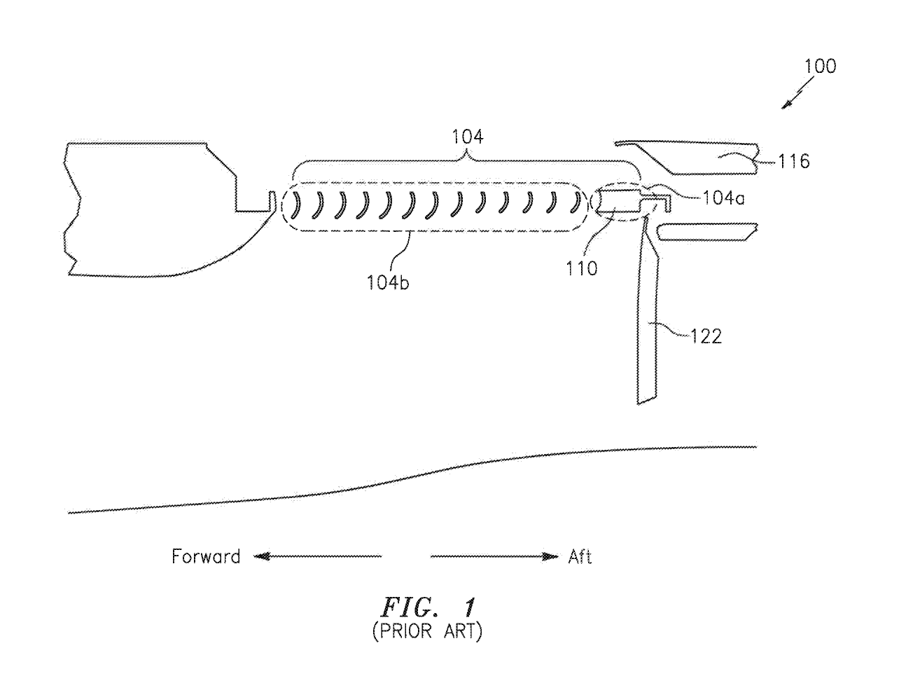

FIG. 2 illustrates a system associated with a thrust reverser in accordance with aspects of this disclosure.

FIG. 3 illustrates a system environment incorporating two cascade vanes in accordance with aspects of this disclosure.

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

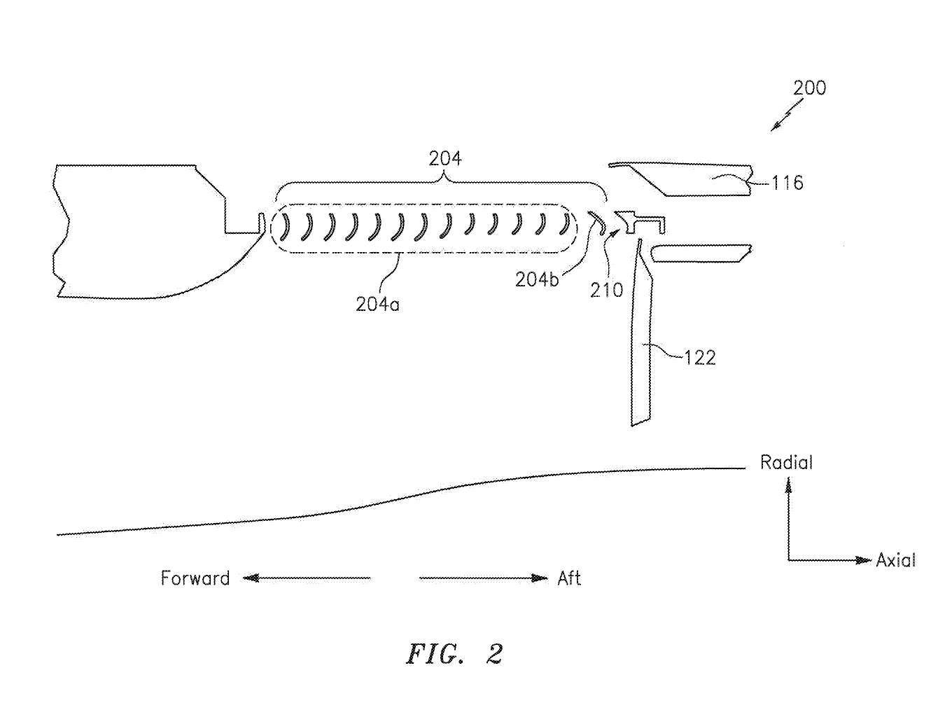

Referring to FIG. 2, a system 200 is shown. The system 200 incorporates some of the components and devices described above in connection with the system 100. As such, a complete re-description is omitted herein for the sake of brevity.

The system 200 may include one or more arrays of vane cascades 204. A first portion/subset of the cascade vanes 204 as denoted/encircled by reference character 204a may have a forward turning angle within a range of, e.g., 0-20 degrees relative to a radial reference direction. For example, the cascade vanes 204a may have a forward turning angle of approximately 15 degrees relative to the radial reference direction.

A second portion/subset of the cascade vanes 204 as denoted by reference character 204b may have a forward turning angle, e.g., within a range of 35-50 degrees relative to the radial reference direction. For example, the cascade vane(s) 204b may have a forward turning angle of approximately 40 degrees relative to the radial reference direction.

As shown in FIG. 2, the cascade vane(s) 204b may be located aft of the cascade vane(s) 204a. The high-forward turning angle associated with the cascade vane(s) 204b may be used to avoid efflux impingement on an inner surface of an outer panel of the translating sleeve 116 while still allowing the cascade vane(s) 204b to be utilized in the production of reverse thrust. In this respect, the forward turning angle associated with the cascade vanes 204b may be selected to be greater than a threshold that is representative of such efflux impingement, which is to say that the forward turning angle may be selected to avoid efflux impingement. Reference character 210 denotes that the system 200 might not include the blocker plate 110 of the system 100, e.g., the system 200 may be blocker-plate free.

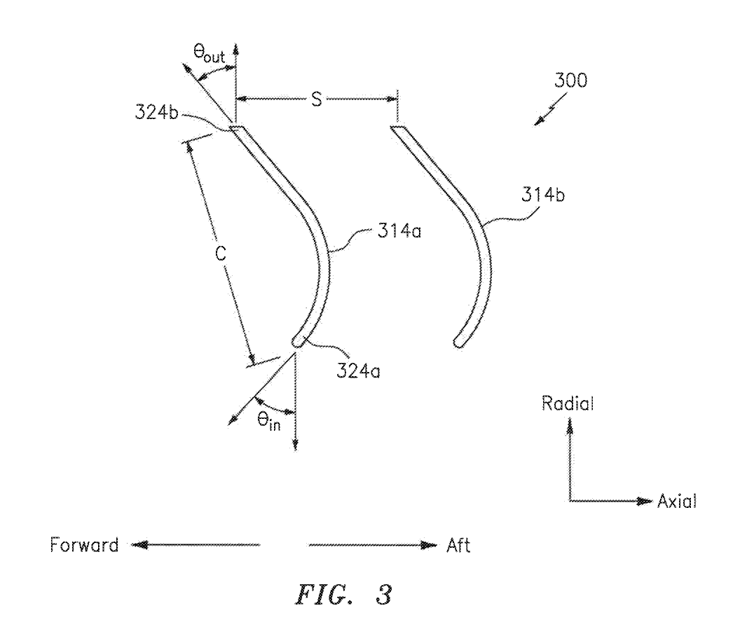

Referring to FIG. 3, an example system environment 300 is shown. The system 300 may be representative of a portion of the cascade vanes 204. The system 300 illustratively includes cascade vanes 314a and 314b. One or both of the cascade vanes 314a and 314b may have a chord length as denoted by reference character ‘C’. The cascade vanes 314a and 314b may be separated from one another by a spacing denoted by reference character ‘S’. As would be appreciated by one of skill in the art, a solidity ratio for the cascade vanes 314a and 314b may be expressed as C/S.

Superimposed at a leading edge 324a of the cascade vane 314a is a reference angle θᵢₙ. θᵢₙ represents the angle of orientation of the cascade vane 314a at the leading edge 324a as measured relative to the radial reference direction, which is generally the radial direction of the turbine engine that is partially housed by the thrust reverser. Also superimposed at a trailing edge 324b of the cascade vane 314a is a reference angle θₒᵤₜ. θₒᵤₜ represents the angle of orientation of the cascade vane 314a at the trailing edge 324b as measured relative to the radial reference direction. θₒᵤₜ is the forward turning angle described above in connection with the cascade vanes 204a and 204b.

In accordance with aspects of this disclosure, limiting the number of cascade vane(s) that include a higher-forward turning angle (e.g., limiting the number of cascade vanes 204b that are used) may avoid appreciably changing the overall efflux pattern of the cascade array 204. In this way, re-ingestion behavior (e.g., avoidance of engine re-ingestion) and fuselage impingement characteristics of the cascade array will not be significantly altered. Such features may be used to retro-fit existing/legacy platforms with platforms adhering to one or more aspects of this disclosure.

Aspects of the disclosure may be used to minimize/reduce a footprint associated with an array of cascades. By utilizing the entirety of the vanes associated with a cascade array, the efficiency of the cascade array may be enhanced in terms of, e.g., production of reverse thrust per unit length of the array. In this respect, additional packaging options for an array of cascades may be obtained.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure.

I claim:

1. A system configured for use in connection with a thrust reverser of an aircraft, comprising:
a first subset of cascade vanes having a first forward turning angle; and
a second subset of cascade vanes having a second forward turning angle that is different from the first forward turning angle.

2. The system of claim 1, wherein the second subset of cascade vanes includes a plurality of cascade vanes.

3. The system of claim 1, wherein the second subset of cascade vanes is a single cascade vane.

4. The system of claim 1, wherein the second subset of cascade vanes are located aft of the first subset of cascade vanes.

5. The system of claim 4, wherein the second forward turning angle is greater than the first forward turning angle relative to a radial reference direction.

6. The system of claim 4, wherein the second forward turning angle is within a range of 35-50 degrees relative to a radial reference direction.

7. The system of claim 4, wherein the second forward turning angle is approximately 40 degrees relative to a radial reference direction.

8. The system of claim 4, wherein the first forward turning angle is within a range of 0-20 degrees relative to a radial reference direction.

9. The system of claim 4, wherein the first forward turning angle is approximately 15 degrees relative to a radial reference direction.

10. The system of claim 1, further comprising:
a blocker door configured to redirect a bypass flow through the first and second subsets of cascade vanes when the thrust reverser is deployed.

11. The system of claim 10, further comprising:
a translating sleeve configured to unblock the first and second subsets of cascade vanes when the thrust reverser is deployed to generate reverse thrust via the first and second subsets of cascade vanes.

12. The system of claim 11, wherein the second forward turning angle is greater than a threshold, and wherein the threshold is based on an avoidance of an efflux impingement upon an inner surface of an outer panel of the translating sleeve when the thrust reverser is deployed.

13. A thrust reverser system of an aircraft comprising;
a translating sleeve at least partially defining a bypass air duct in which a bypass air flow from a turbofan engine passes, the translating sleeve configured to translate in a generally forward-aft direction between a stowed position and a deployed position;
a set of blocker doors linked to the translating sleeve which are positioned inside of the bypass air duct and at least partially block the bypass air flow when the translating sleeve is in the deployed position and are positioned in a second stowed position not blocking the bypass air flow when the translating sleeve is in the stowed position;
a cascade array which is blocked by the translating sleeve when the translating sleeve is in the stowed position and is exposed by the translating sleeve when the translating sleeve is in the deployed position, the cascade array configured to redirect the bypass air flow in a generally forward direction when the translating sleeve is in the deployed position;
the cascade array including a first subset of cascade turning vanes having a first forward turning angle, and a second subset of cascade vanes positioned aft of the first subset and having a second forward turning angle that is greater than the first forward turning angle.

14. The thrust reverser system of claim 13, wherein the first forward turning angle and the second forward turning angle are measured relative to a radial reference direction.

15. The thrust reverser system of claim 14, wherein the first forward turning angle is within a range of 0-20 degrees, and wherein the second forward turning angle is within a range of 35-50 degrees.
